(19) United States
(12) Patent Application Publication
(10) Pub. No.: US 2007/0123608 A1
(43) Pub. Date: May 31, 2007

(54) PROCESS FOR PRODUCING LIQUID COMPOSITION AND IMAGE FORMING METHOD AND APPARATUS

(76) Inventors: Kazumichi Nakahama, Tokyo (JP); Takayuki Teshima, Yokohama-shi (JP); Yukio Hanyu, Isehara-shi (JP); Mamoru Sakashita, Tsukui-gun (JP)

Correspondence Address: MORGAN & FINNEGAN, L.L.P., 3 WORLD FINANCIAL CENTER, NEW YORK, NY, 10281-2101, US

(21) Appl. No.: 11/552,338

(22) Filed: Oct. 24, 2006

(30) Foreign Application Priority Data
Oct. 27, 2005 (JP) 2005-313401

(51) Int. Cl. C09D 11/00

(52) U.S. Cl. 523/160

(57) ABSTRACT

A process for producing a liquid composition containing polymeric pigment fine particles including a pigment and a polymeric compound which is soluble in an aprotic solvent and hardly soluble in a poor solvent for the pigment is constituted by a step of preparing a solution of the pigment and the polymeric compound in the aprotic solvent in the presence of alkali; and a step of mixing the solution with the poor solvent for the pigment to precipitate the polymeric pigment fine particles comprising the pigment and the polymeric compound in a dispersion state.

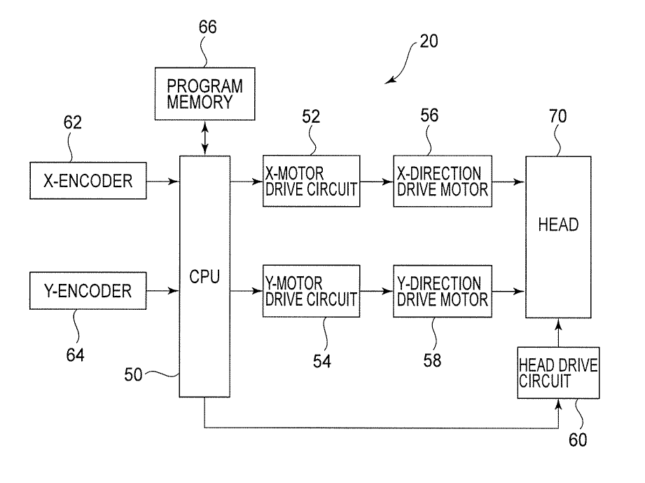

### FIELD OF THE INVENTION AND RELATED ART

The present invention relates to a process for producing a liquid composition, containing pigment fine particles in a dispersion state, useful as an ink composition for ink jet recording and an image forming method and an image forming apparatus which use the liquid composition.

In recent years, digital printing technologies are rapidly progressing. In these digital printing technologies, electrophotography or ink jet technology is a representative example and currently strengthens increasingly its presence in office, home, etc., as image forming technology.

Especially, the ink jet technology has great characteristic features of compact and low power consumption as a direct recording method. Further, realization of minute nozzles or the like has rapidly promoted provision of high image quality. As an example of the ink jet technology, there is a method of forming an image on a recording medium by heating ink supplied from an ink container by means of a heater in a nozzle to cause vaporization and bubble generation, thus ejecting the ink from the nozzle. As another example, it is also possible to use such a method that a piezoelectric element is vibrated to eject ink from a nozzle.

In these methods, water-soluble dye ink is conventionally used. However, the use of water-soluble dye ink has accompanied with a problem in terms of blur, feathering, weather resistance, etc. In order to solve the problem, in recent years, utilization of pigment ink has been studied as in U.S. Pat. No. 5,085,698. Further, ink for ink jet comprising an ink composition containing pigment fine particles is actually becoming popular.

The pigment ink is, however, inferior to the dye ink in many cases in terms of long-term storage stability and ejection stability from ink jet head. Further, the pigment ink causes scattering and reflection of light, so that an image formed with the pigment ink is generally liable to have a low color developing performance compared with an image formed with the dye ink.

As one of methods of improving the color developing performance, an attempt to provide fine pigment particles has been made. Pigment finely divided into a particle size of 100 nm or less (hereinafter, referred to as “pigment fine particles”) is less affected by light and increases in specific surface area, so that it has been expected to provide a color developing performance comparable to that of the dye.

Fine division of the pigment particles is generally performed by a dispersing device such as a sand mill, a roll mill, or a ball mill. However, the use of the dispersing device has a limit of fine division such that the pigment particles are finely divided into primary particle or the like (approximately 100 nm) . In the case where further fine division of the pigment particles is required, it is not only necessary to take a lot of time and cost but also difficult to stably supply pigment fine particles having a uniform quality (Japanese Laid-Open Patent Application (JP-A) Hei 10-110111).

Another method of adjusting minute pigment particles by precipitating pigment after dissolving it in a solvent has been proposed (JP-A Hei 9-221616). In this method, an acid pasting method using concentrated sulfuric acid in a dissolving step of pigment is used. However, this method has not provided pigment fine particles of 100 nm or less.

Further, Japanese Patent Publication (JP-B) Hei 6-96679 has proposed such a method that an organic pigment and a dispersing agent are dissolved in an aprotic solvent or nonprotic solvent in the presence of alkali and then the resultant solvent is neutralized with acid to obtain pigment fine particles. However, according to study of the present inventors, the thus obtained pigment fine particles has a dispersibility in an aqueous solvent containing water such that it is not sufficient to satisfy a degree suitable for, e.g., aqueous ink for ink jet. More specifically, in this method, a neutralization precipitation method in which acid is added dropwise to the pigment solution is employed. As a result, a precipitation speed and agglomeration speed of pigment are large, so that it can be assumed that the dispersing agent is not uniformly adsorbed at surfaces of the pigment fine particles to lower dispersion stability.

Further, JP-A 2004-43776 discloses a method in which pigment fine particles excellent in dispersibility are successfully adjusted by dissolve an organic pigment and an aqueous dispersing agent in an aprotic solvent in the presence of alkali and then mixing the resultant solution with water. This method is characterized in that it causes precipitation of pigment in a milder condition than that of the neutralization precipitation in JP-B Hei 6-96679, thus being liable to obtain pigment fine particles. In this method, however, the aqueous dispersing agent is soluble in water, so that an adsorption speed thereof with respect to pigment particles is moderate. As a result, there arises problem that agglomeration between pigment fine particles is liable to occur. In this case, when the mixing of the pigment solution with water is not complete, there is a possibility that pigment fine particles having a desired particle size cannot be obtained uniformly.

### SUMMARY OF THE INVENTION

The present invention has been accomplished in view of the above described circumstances.

An object of the present invention is to provide a process for producing a liquid composition in which polymeric pigment fine particles having a particle size with high uniformity on the order of nanometers are contained in a dispersion state.

Another object of the present invention is to provide an ink composition for ink jet recording using the ink composition containing the liquid composition and to provide an image forming method and image forming apparatus using the ink composition.

According to an aspect of the present invention, there is provided a process for producing a liquid composition containing polymeric pigment fine particles comprising a pigment and a polymeric compound which is soluble in an aprotic solvent and hardly soluble in a poor solvent for the pigment, said process comprising:

a step of preparing a solution of the pigment and the polymeric compound in the aprotic solvent in the presence of alkali; and

a step of mixing the solution with the poor solvent for the pigment to precipitate the polymeric pigment fine particles comprising the pigment and the polymeric compound in a dispersion state.

These and other objects, features and advantages of the present invention will become more apparent upon a consideration of the following description of the preferred embodiments of the present invention taken in conjunction with the accompanying drawings.

### BRIEF DESCRIPTION OF THE DRAWING

The sole figure is a block diagram showing a constitution of an ink jet recording apparatus.

### DETAILED DESCRIPTION OF THE PREFERRED EMBODIMENTS

The present inventors have conducted studies on precipitate behavior of pigment in reprecipitation method, adsorption behavior of dispersing agent onto pigment fine particles, and various factors effecting dispersion stability of formed pigment fine particles in an aqueous solution. As a result, the present inventors have found that it is possible to provide a liquid composition characterized by containing pigment fine particles excellent in dispersion stability by optimizing a solvent used and defining a solubility of dispersing agent in the solvent, thus accomplishing the present invention.

More specifically, according to a first aspect of the present invention, there is provided a process for producing a liquid composition containing polymeric pigment fine particles comprising a pigment and a polymeric compound which is soluble in an aprotic solvent and hardly soluble in a poor solvent for the pigment, said process comprising:

a step of preparing a solution of the pigment and the polymeric compound in the aprotic solvent in the presence of alkali; and

a step of mixing the solution with the poor solvent for the pigment to precipitate the polymeric pigment fine particles comprising the pigment and the polymeric compound in a dispersion state.

The poor solvent for the pigment may preferably be water or a solution having a pH of 5 or more. Further, when the polymeric compound has a solubility parameter δp, the aprotic solvent has a solubility parameter δo, and the poor solvent has a solubility parameter δw, the solubility parameters δp, δo, and δw satisfying the following relationships:
   |δp−δo| is 1.8 or less, and
   |δp−δw| is more than 0.5.

The polymeric compound may preferably be a copolymer having a hydrophilic site and a hydrophobic group. Further, the copolymer may preferably be a block copolymer.

According to a second aspect of the present invention, there is provided an ink composition for ink jet recording, comprising:

a liquid composition produced through the above described process for producing the liquid composition.

According to a third aspect of the present invention, there is provided an image forming method, comprising:

a step of recording an image by providing the above described ink composition to a medium.

According to a fourth aspect of the present invention, there is provided an image forming apparatus, comprising:

means for recording an image by providing the above described ink composition to a medium.

According to the present invention, there is provided a liquid composition in which polymeric pigment fine particles having a highly uniform particle size on the order of nanometers are contained in a dispersion state. Further, the present invention also provides an image forming method and image forming apparatus using an ink composition containing the liquid composition described above.

Hereinbelow, the present invention will be described more specifically.

The process for producing a liquid composition containing polymeric pigment fine particles comprising a pigment and a polymeric compound which is soluble in an aprotic solvent and hardly soluble in a poor solvent for the pigment includes the following steps (1) and (2):

(1) a step of preparing a solution of the pigment and the polymeric compound in the aprotic solvent in the presence of alkali (hereinafter, referred to as a “solution A”), and

(2) a step of mixing the solution A with the poor solvent for the pigment (hereinafter, referred to as a “solution B”) . Through these steps (1) and (2), the liquid composition in which polymeric pigment fine particles having a highly uniform particle size on the order of nanometers are precipitated in a dispersion state can be obtained.

In the present invention, a mechanism for obtaining the polymeric pigment fine particles in such that when the solution A and the solution B are mixed, the pigment dissolved in the solution A is abruptly insolubilized to form seed (core) particles and the polymeric compound functions as a dispersing agent for the seed particles during agglomeration of the seed particles to form polymeric pigment fine particles.

(Polymeric Compound)

The polymeric compound will be described. In order to form the polymeric pigment fine particles having the highly uniform particle size on the order of nanometers, it is necessary to efficiently suppress agglomeration of the seed particles of pigment precipitated by abrupt insolubilization due to the mixing the solution A with the solution B. In other words, it is necessary to disperse and stabilize the precipitated seed particles of pigment by the polymeric compound before the agglomeration between the seed particles proceeds considerably. For this purpose, it is necessary to use a polymeric compound, having a large adsorption or precipitated speed onto the pigment surface, as a dispersing agent.

In the present invention, in view of the above requirements, it is possible to use a polymeric compound satisfying the following physical property and the polymeric compound can achieve the objects of the present invention. More specifically, the polymeric compound usable in the present invention is hardly or poorly soluble in the solution B and is soluble in the aprotic solvent constituting the solution A.

The reason why the polymeric compound is required to be hardly soluble in the solution B will be described.

In order to disperse and stabilize the pigment seed particles, precipitated by abrupt insolubilization due to the mixing between the solutions A and B, with the polymeric compound before the agglomeration between the pigment seed particles proceeds considerably, it is necessary to use a polymeric compound having a high speed of adsorption onto the pigment surface. The polymeric compound hardly soluble in the solution B is precipitated at the pigment surface efficiently, so that it can effective coat the pigment seed particles. By the use of such a polymeric compound, it is possible to produce the polymeric pigment fine particles on the order of nanometers.

On the other hand, in the case of applying the polymeric compound soluble in the solution B, the polymeric compound in the mixture of the solutions A and B has a slower speed of adsorption onto the pigment surface than the polymeric compound hardy soluble in the solution B. For this reason, agglomeration considerably proceeds between the pigment seed particles, so that it is difficult to produce the polymeric pigment fine particles having the highly uniform particle size on the order of nanometers.

Next, the reason why the polymeric compound is required to be soluble in the aprotic solvent constituting the solution A will be described.

In order to disperse and stabilize the pigment seed particles, precipitated by abrupt in solubilization due to the mixing between the solutions A and B, with the polymeric compound before the agglomeration between the pigment seed particles proceeds considerably, it is necessary to precipitate the polymeric compound at the pigment surface efficiently. Herein, in the case where the polymeric compound hardly soluble in the aprotic solvent constituting the solution A is used as the dispersing agent, the polymeric compound forms particles by itself. For this reason, the polymeric compound cannot be efficiently diffused and adsorbed onto the pigment seed particles, so that only coarse pigment particles are obtained.

As an index representing solubility between the polymeric compound and a solvent, there is a solubility parameter (SP) . A value of SP is a physical value defined as (ΔE^{v}/V)^{1/2} wherein Aver represents molar evaporation energy and V represents a molar volume and can be determined by calculations from not only chemical composition but also heat of vaporization, refractive index, surface tension, etc.

Generally, in the case of consider the solubility between the polymeric compound and the solvent, the polymeric compound is soluble in the solvent when an absolute value of difference between an SP value 51 of the polymeric compound and an SP value 52 of the solvent, i.e., |δ1−δ2| is 1.8 or less. Further, when |δ1−δ2| is 0.5 or less, the polymeric compound is well dissolved in the solvent. On the other hand, when |δ1−δ2| is more than 1.8, the polymeric compound is hardly soluble or insoluble in the solvent.

In the present invention, a dissolution characteristic of the polymeric compound can be determined by using the SP value.

More specifically, when the polymeric compound used in the present invention has an SP value δp, the aprotic solvent constituting the solution A has an SP value So, and the solution B has an SP value δw, the objects of the present invention can be accomplished in the case where |δp−δo) is 1.8 or less and |δp−δw| is more than 1.5. In a preferred embodiments, |δp−δo| is 1.8 or less and |δp−δw| is more than 1.8. In a further preferred embodiment, I δp−δo| is 0.5 or less and |δp−δw| is more than 1.8.

However, it should be noted that there is a limit to the discussion about the solubility based on the SP values. For example, in the case where a solvent having a large polarity such as water is used, it is not appropriate that the solubility of the polymeric compound is predicted from the SP value thereof but evaluation by experiment is essential. For this reason, in the present invention, solubility and poor solubility of the polymeric compound in the solution A and the solution B are evaluated by a solubility test described below.

First, the polymeric compound is mixed in the solution A or the solution so that it has a concentration of 3 wt. %. The mixture is shaken at 25° C. for 24 hours and then left standing for 24 hours. When the resultant mixing state in uniform, the dissolution characteristic of the mixture is defined as solubility (soluble state) . On the other hand, when the mixing state is such an incomplete dissolution state that it assumes gel-like or particulate appearance or clear turbidity, the dissolution characteristic of the mixture is defined as poor solubility (hardly soluble state) . Herein, the term “poor solubility or hardly soluble (state)” include a so-called insoluble state in which the polymeric compound and the solvent do not interact with each other. In the case where it is difficult to determine the dissolution characteristic by eye observation, it is possible to measure a transmittance of a solution or dispersion in which the polymeric compound is dissolved or dispersed as an index of the dissolution characteristic. In this case, in the present invention, when the transmittance is 99% or more, the solution or dispersion is defined as “soluble”. When the transmittance is less than 99%, the solution dispersion is defined as “hardly (or poorly) soluble”. The transmittance can be measured by a known method. In the present invention, a transmittance at 500 nm is measured by double beam spectrophotometer (Model “U-2001”, mfd. by Hitachi, Ltd.) and a measured value is subjected to evaluation.

The polymeric compound in the present invention is constituted by a hydrophilic site and a hydrophobic site as the polymeric compound, it is preferable that a copolymer prepared by copolymerizing a hydrophilic monomer component and a hydrophobic monomer component as desired is used. In the case of using a polymeric compound which is a polymer of only the hydrophobic monomer component, it is difficult to impart good dispersion stability to the polymeric pigment fine particles. Incidentally, the term “hydrophilic” means a property of having a large affinity for water and being liable to be dissolved in water. The term “hydrophobic” means a property of having a small affinity for water and being less liable to be dissolved in water.

For example, as the hydrophilic monomer component, it is possible to use a monomer component having, as a unit structure, a hydrophilic unit such as carboxylic acid, carboxylate, a structure principally containing a hydrophilic oxyethylene unit, or a structure having a hydroxyl group.

Examples of the hydrophilic monomer component may include acrylic acid and methacrylic acid; carboxylate such as inorganic salts or organic salts thereof; polyethylene glycol macromonomer; vinyl alcohol; and 2-hydroxyethyl methacrylate. However, in the present invention, the hydrophilic monomer component constituting the hydrophilic site of the polymeric compound is not limited thereto.

Further, as the hydrophobic monomer component, it is possible to use a monomer component having, as a unit structure, a hydrophobic unit such as isobutyl group, t-butyl group, phenyl group, biphenyl group, or naphthyl group. Examples of the hydrophobic monomer component may include such a block segment having, as a recurring unit, a hydrophobic monomer such as styrene or t-butyl methacrylate. However, in the present invention, the hydrophobic monomer component constituting the hydrophobic site of the polymeric compound is not limited thereto.

The above described copolymer may be any copolymer such as random copolymer, block copolymer or graft-copolymer. Particularly, the use of the block copolymer or the graft copolymer is preferable since such a copolymer is liable to impart good dispersion stability to the polymeric pigment fine particles.

The polymeric compound used in the present invention is constituted by a copolymer prepared by copolymerizing the above described hydrophilic monomer component and hydrophobic monomer component and is required to have such a characteristic that it is soluble in the aprotic solvent and is hardly soluble in the poor solvent for the pigment. For this purpose, it is desirable that the polymeric compound which is soluble in the aprotic solvent and hardly soluble in the poor solvent for the pigment is prepared by appropriately select the kind and proportion of the hydrophilic monomer composition and the hydrophobic monomer composition of the polymeric compound.

In the present invention, the polymeric compound has a weight-average molecular weight (Mw) of 500-1,000,000, preferably 1,000-1,000,000. When the polymeric compound has the Mw of above 1,000,000, entanglement within a polymer chain or between polymer chains is excessively increased. On the other hand, when the polymeric compound has the molecular weight of below 500, the small molecular weight polymeric compound less exhibits the function as the dispersing agent, so that it cannot impart good dispersion stability to the polymeric pigment fine particles.

The Mw of the polymeric compound can be measured by light scattering method, small-angle X-ray scattering method, sedimentation equilibrium method, diffusion method, ultracentrifugation, or various chromatography. In the present invention, the Mw is a polystyrene-conversion Mw measured according to gel permeation chromatography (GPC; polystyrene standards).

The polymeric compound in the present invention can be used singly or in combination of two or more species. An amount of use of the polymeric compound is not particularly limited but may preferably be used in the range of 0.05 wt. part or more per 1 wt. parts of the pigment and 50 wt. parts or less per 100 wt. parts of the aprotic solvent.

When the polymeric compound is contained in an amount of more than 50 wt. parts per 100 wt. parts of the aprotic solvent, it is difficult to completely dissolve the polymeric compound in the aprotic solvent in some cases. Further, when the polymeric compound is added in an amount of less than 0.05 wt. part per 1 wt. part of the pigment, a sufficient dispersion effect cannot be achieved in some cases.

(Mixing Method of Solutions A and B)

In order to obtain the polymeric pigment fine particles having the highly uniform particle size on the order of nanometers, it is preferable than the solutions A and B are mixed as quickly as possible.

For this purpose, it is possible to use, as a mixing device, any conventionally known apparatuses for stirring, mixing, dispersion, and crystallization such as ultrasonic transducer, full-zone stirrer, internal circulation-type stirring apparatus, external circulation-type stirring apparatus, and flow and ion concentration control apparatus. Further, the solutions A and B may also be mixed in continuously flowing water. As a method of adding the pigment solution into water, it is possible to utilize any conventionally known liquid injection method. However, it is preferable that the pigment solution is injected from the inside of water or above water through a nozzle such as syringe, needle or tube in the form of jet. In this case, it is also possible to eject the pigment solution from a plurality of nozzles so as to complete the ejection in a short time. Further, in order to stably prepare the polymeric compound, it is also possible to add additives such as alkali and dispersing agent into the solution B to be mixed with the solution A.

Further, during the mixing of the solutions A and B, a temperature is not particularly set but may preferably be adjusted in the range of −50 to 100° C., more preferably −20 to 50° C. The temperature during the mixing largely affects a particle size of organic pigment to be precipitated, so that the solution temperature may preferably be controlled in the ranged of −50 to 100° C. in order to obtain the polymeric pigment fine particles on the order of nanometers. Further, in this case, in order to ensure flowability of the solutions, it is possible to add a known freezing-point depressant such as ethylene glycol, propyrene glycol, or grycerin into water to be mixed.

(Concentration and Purification)

The polymeric pigment fine particles obtained by mixing the solutions A and B are usable as they are but may also be used in various uses by effecting concentration and purification thereof as desired. The concentration and purification can be effected by using any conventionally known apparatus used in concentration and purification such as a centrifugal separator, evaporator, or ultrafilter.

(Pigment)

The pigment used in the present invention may be any pigment so long as it is dissolved together with the polymeric compound in the aprotic solvent in the presence of alkali. In a preferred embodiment, such a stable organic pigment which does not assume reactivity in this condition can be used. More specifically, organic pigments used in printing ink, paint and the like can be used.

Examples of the pigment may include pigments of azo-type, disazo-type, anthraquinone-type, dianthraquinonyl-type, anthrapyridine-type, anthanthrone-type, thioindigo-type, naphthol-type, benzoimidazolone-type, pyranthrone-type, phthalocyanine-type, flavanthrone-type, quinacridone-type, diozazine-type, diketopyroropyrrole-type, indanthrone-type, isoindorinone-type, isoindorine-type, quinophthalone-type, perinone-type, and perylene-type; vat dye-based pigments; metal complex pigments; basic dye-based; fluorescent pigments; and daylight fluorescent pigments.

Specific examples of the pigments may include C.I. Pigment Yellow 1, 3, 12, 13, 14, 17, 42, 55, 62, 73, 74, 81, 83, 93, 95, 97, 108, 109, 110, 128, 130, 151, 155, 158, 139, 147, 154, 168, 173, 180, 184, 191 and 199; C.I. Pigment Red 2, 4, 5, 22, 23, 31, 48, 53, 57, 88, 112, 122, 144, 146, 150, 166, 171, 175, 176, 177, 181, 183, 184, 185, 202, 206, 207, 208, 209, 213, 214, 220, 254, 255, 264 and 272; C.I. Pigment Blue 16, 25, 26, 56, 57, 60, 61 and 66; C.I. Pigment Violet 19, 23, 29, 37, 38, 42, 43 and 44; C.I. Pigment Orange 16, 34, 35, 36, 61, 64, 66, 71 and 73; and C.I. Pigment Brown 23 and 38.

These organic pigments may be used singly or in mixture of two or more species.

(Aprotic Solvent)

As the aprotic solvent used in the present invention may be any solvent so long as it dissolves the organic pigment and the polymeric compound in the presence of alkali and can accomplish the objects of the present invention. Further, an aprotic solvent having a solubility in water of 5 wt. % or more may preferably be used. An aprotic solvent which can be freely mixed in water may more preferably be used. In the case where the pigment is solubilized by using a solvent having a solubility in water of less than 5 wt. %, pigment-containing particles is less precipitated during the mixing with water, so that they are liable to disadvantageously form coarse particles. Further, it is also disadvantageous in that it is liable to adversely affect a dispersion stability of the resultant polymeric pigment fine particles.

Examples of the aprotic solvent may include dimethyl sulfoxide (DMSO), dimethylimidazolidinone, sulfolane, N-methyl pyrrolidone, dimethylformamide, acetonitrile, acetone, dioxane, tetramethylurea, hexamethylphosphoramide, hexamethylphoshphortriamide, pyridine, propionitrile, butanone, cyclohexane, tetrahydrofuran, tetrahydropyran, ethylene, glycol diacetate, and γ-butyrolactone. Of these, dimethyl sulfoxide, N-methyl pyrrolidone, dimethylformamide, dimethylimidazolidinone, sulfolane, acetone, acetonitrile, and tetrahydrofuran may preferably be used. These may be used singly or in mixture of two or more species.

An amount of use of the aprotic solvent described above is not particularly limited but the aprotic solvent may preferably be used in an amount of 2-500 wt. parts, preferably 5-100 wt. parts, per 1 wt. part of the pigment in order to realize a better dissolution state of the pigment, ease of formation of a desired particle size of fine particles, and better color density of the aqueous dispersion.

(Alkali)

The alkali used in the present invention may be any one so long as it dissolves the pigment in the aprotic solvent and can accomplish the objects of the present invention. Particularly, hydroxide of alkali metal, alkoxide of alkali metal, hydroxide of alkaline-earth metal, alkoxide of alkaline-earth metal, and organic strong base may preferably be used in terms of high solubilizing ability for the pigment.

Examples of the alakli may include lithium hydroxide, sodium hydroxide, potassium hydroxide, calcium hydroxide, potassium-tert-butoxide, potassium methoxide, potassium ethoxide, sodium methoxide, sodium ethoxide, quaternary ammonium compounds such as tetramethyl ammonium hydroxide and tetrabutyl ammonium hydroxide, 1,8-diazabicyclo[5,4,0]-7-undecene, 1,8-diazabicyclo[4,3,0]-7-nonene, and quanidine. These alkalis may be used singly or in mixture of two or more species.

An amount of use of the alkali is not particularly limited but the alkali may preferably be used in an amount of 0.01-1000 wt. parts per 1 wt. part of pigment. Below 0.01 wt. part, there is a disadvantageous tendency that it is difficult to completely dissolve the pigment together with the polymeric compound in the aprotic solvent. Above 1000 wt. parts, the alkali is less dissolved in the aprotic solvent, so that an increase in solubility of the pigment cannot be expected in some cases.

(Additives)

In order to completely dissolve the alkali in the aprotic solvent, it is possible to add some amount of a solvent having a high solubility in alkali such as water or lower alcohol into the aprotic solvent. This solvent functions as an alkali-solubilizing aid, so that a solubility of the alkali in the aprotic solvent is increased, thus facilitating dissolution of the pigment. However, when the alkali-solubilizing aid is added in an amount of 50 wt. % or more per the entire solvent amount, the solubility of the pigment is disadvantageously decreased. The addition amount is most effective when it is ordinarily about 0.5-30 wt. %.

This is because the aprotic solvent alone has a relatively low solubility of alkali. More specifically, it is possible to use, in combination with the aprotic solvent, the alkali-solubilizing aid such as water, methanol, ethanol, n-propanol, isopropanol, or butyl alcohol. During the dissolution of the pigment, in order to quickly dissolve the pigment by suppressing the amount of the alkali used to a minimum, the alkali may preferably be added as a solution thereof in water or lower alcohol until the pigment is dissolved in the aprotic solvent. In this case, the pigment is in the form of solution, so that it is possible to easily effect removal of contamination or the like. In selection of such an alkali-solubilizing aid, it is important that a compatibility with the dispersing agent is ensured.

During the dissolution of the pigment in the aprotic solvent, in addition to the pigment and the polymeric compound, it is possible to add at least one species of a crystal growth inhibitor, an ultraviolet absorber, an antioxidant, and a resin additive into the aprotic solvent. As the crystal growth inhibitor, it is possible to use a phthalocyanine derivative and a quinacridone derivative which are well known in the art. Examples thereof may include phthalimide methyl derivative of phthalocyanine, sulfonic acid derivative of phthalocyanine, N-(dialkylamino)methyl derivative of phthalocyanine, phthalimide methyl derivative of quinacridone, sulfonic acid derivative of quinacridone, N-(dialkylamino)methyl derivative of quinacridone, and N-(dialkylaminoalkyl)sulfonamide derivative of quinacridone.

Examples of the ultraviolet absorber may include metal oxide, and ultraviolet absorbers of aminobenzoate-type, salicylate-type, benzophenone-type, benzotriazole-type, cinnamate-type, nickel chelate-type, hindered amine-type, urocanic acid-type, and vitamin-type.

Examples of the antioxidant may include a hindered phenol-type compound, a thioalkanoic acid ester compound, an organic phosphorus compound, and aromatic amine.

Examples of the resin additive may include synthetic resins including anion-modified polyvinylalcohol, cation-modified polyvinylalcohol, polyurethane, carboxymethyl cellulose, polyester, polyallylamine, polyvinyl pyrrolidone, polyethyleneimine, polyamine sulfone, polyvinylamine, hydroxyethyl cellulose, hydroxypropyl cellulose, melamine resin, and their modified products.

The above described crystal growth inhibitor, ultraviolet absorber, and the resin additive may be used singly or in mixture of two or more species.

(Poor Solvent)

The poor solvent used in the present invention is a poor solvent for the pigment. The poor solvent may be any one so long as it has a compatibility with the aprotic solvent used and can achieve the objects of the present invention. However, water or an aqueous solution having a pH of 5 or more, preferably 6.5 or more may particularly be used preferably. By using water or the aqueous solution of pH=5 or more as the solution B, it is possible to precipitate the pigment in a mild condition during the mixing of the solution A with the solution B. When an acid having a pH of less than 4 is used as the solution B, the pigment is abruptly precipitated during the mixing of the solution A with the solution B, so that the polymeric compound cannot be efficiently adsorbed as the dispersing agent onto the pigment surface. As a result, coarse pigment particles are liable to be formed.

Into water or the aqueous solution used, it is possible to add in additive. This additive may be any one so long as it has a compatibility with water or the aqueous solution and can achieve the objects of the present invention. Examples of the additive may include the above described alkalis known pH adjusters such as pH buffer, and salts. Further, in order to enhance the compatibility of the aprotic solvent with water or the aqueous solution, for example, it is possible to add an organic solvent such as alcohol etc. In this case, the organic solvent added is not limited to alcohol but may also be any organic solvent so long as it can accomplish the objects of the present invention.

(Polymeric Pigment Fine Particles)

In the present invention, the polymeric pigment fine particles are constituted by the pigment and the polymeric compound which is soluble in the aprotic solvent and hardly soluble in the poor solvent for the pigment. More specifically, the polymeric pigment fine particles are constituted by the pigment specifically described above and the polymeric compound specifically described above.

In the liquid composition, the polymeric pigment fine particles are characterized in that they are held in a good dispersion state. Further, the polymeric pigment fine particles have the highly uniform particle size on the order of nanometers. More specifically, the polymeric pigment fine particles have an average particle size of 1-100 nm, preferably 20-80 nm. Below 1 nm, a weather resistance can be lowered. Above 100 nm, they are largely affected by particle property, so that there is possibility that transparency thereof is impaired.

(Ink Composition)

When the liquid composition of the present invention is used as the liquid composition, it is possible to add various additives and aids and the like as desired. One of the additives may be a dispersing agent for stably dispersing the pigment in the solvent.

The polymeric pigment fine particles contained in the liquid composition produced by the process of the present invention is dispersed and stabilized by the polymeric compound constituting the polymeric pigment fine particles. However, in the case of insufficient dispersion, it is also possible to add another dispersion stabilizer.

As another dispersion stabilizer, it is possible to use a resin material having both of a hydrophilic portion and a hydrophobic portion or a surfactant. Examples of the resin material may include a copolymer between a hydrophilic monomer and a hydrophobic monomer.

Examples of the hydrophilic monomer may include acrylic acid, methacrylic acid, maleic acid, fumaric acid, monoesters of these carboxylic acids, vinyl sulfonic acid, styrene sulfonic acid, vinyl alcohol, acrylamide, and methacryloxyethyl phosphate.

Examples of the hydrophobic monomer may include styrene derivatives such as styrene and α-methylstyrene; vinylcyclohexane; vinylnaphthalene derivatives; acrylates; and methacrylates.

Examples of the copolymer may include various copolymers such as random copolymer, block copolymer, and graft copolymer.

The hydrophilic monomer and the hydrophobic monomer usable in the present invention are not limited to those described above.

The surfactant may include anionic surfactant, nonionic surfactant, cationic surfactant, and ampholytic surfactant.

Examples of the anionic surfactant may include fatty acid salt, alkyl sulfate, alkylallyl sulfate, alkyldiallylether disulfate, dialkylsulfosuccinate, alkyl phosphate, naphthalenesulfonic acid-formaldehyde condensate, polyoxyethylenealkyl phosphate, and glycerol borate fatty acid ester.

Examples of the nonionic surfactant may include polyoxyethylene alkyl ether, polyoxylethylene oxypropylene block copolymer, sorbitan fatty acid ester, glycerin fatty acid ester, polyoxyethylene fatty acid ester, polyoxyethylene alkylamine, fluorine-containing surfactant, and silicon-containing surfactant.

Examples of the cationic surfactant may include alkylamine salt, quaternary ammonium salt, alkylpyridinium salt, and alkylimidazolium salt.

Examples of the ampholytic surfactant may include alkylbetaine, alkylamine oxide, and phosphatidyl choline.

The surfactant usable in the present invention is also not limited to those described above.

Into the ink composition of the present invention, it is possible to add an aqueous solvent as desired. Particularly, in the case of use in ink for ink jet, the aqueous solvent is used for preventing drying and solidification of ink at a nozzle portion and can be used singly or in mixture of two or more species.

As the aqueous solvent, it is possible to use the substances for another dispersion stabilizer as they are. The aqueous solvent may be used in an amount of 0.1-60 wt. %, preferably 1-40 wt. %, per the entire weight of ink in the case of being used in the ink composition.

As other additives, e.g., in the case where the liquid composition is used as the ink composition, it is also possible to add a pH adjuster for stabilizing ink in an ink container and piping of a recording apparatus; a penetrant for permitting early penetration of ink into a recording medium to facilitate early apparent drying; an antifungal agent for preventing an occurrence of mold in the ink; a chelating agent for preventing precipitation or the like of metal at the nozzle portion and insoluble matter in the ink by blocking metal ions in the ink; an antifoaming agent for preventing generation of bubble during circulation and movement of recording liquid or production of the recording liquid; a fungicide; a viscosity-adjusting agent; an electroconductivity-imparting agent; ultraviolet absorber; and the like.

In order to prepare the ink composition of the present invention, the liquid composition of the present invention is mixed with the above described constitutional components so as to be uniformly dissolved or dispersed. Further, in the case where the thus prepared ink composition contains an excessive amount of the polymeric compound and the additives, they can be appropriately removed by a known method such as centrifugal separation or dialysis to reprepare the ink composition.

(Image Forming Method and Apparatus)

The ink composition of the present invention is usable in various image forming methods and apparatuses using various printing methods, ink jet method, electrophotography, etc. Further, it is possible to form an image by the image forming method using the image forming apparatus. In the case of using the liquid composition in, e.g., the ink jet method, the liquid composition can be used in a liquid-imparting method for forming a fine pattern or administering drugs.

The image forming method of the present invention effects excellent image formation using the ink composition of the present invention. In a preferred embodiment of the image forming method, recording is effected by ejecting the ink composition from an ink ejecting portion onto a medium to be recorded. For image formation, such an ink jet method that ink is ejected by applying heat energy to the ink may preferably be used.

In the present invention, it is also possible to suppress blur and feathering on the medium to be recorded by using stimulus with polyvalent cation in combination. The block polymer compound usable in the present invention is, as described above, characterized in that it contains a recurring unit having a polycyclic aromatic organic acid. The polycyclic aromatic organic acid has strong hydrophobicity, so that it is liable to interact with the polyvalent cation, thus being liable to cause agglomeration.

For this reason, in the case where the polyvalent cation is present on the member to be recorded, the ink composition is quickly agglomerated. As a result, it is also possible to provide an ink composition and liquid-imparting method and apparatus which are improved in blur and feathering on the medium to be recorded.

The polyvalent cation may preferably be metal cation, examples thereof may include bivalent cations such as Ca, Cu, Mg, Ni, Zn, Fe and Co and trivalent cations such as Al, Nd, Y, Fe, and La. Examples of non-metal cation as the polyvalent cation may include diammonium cation and triammonium cation. The polyvalent cation usable in the present invention is not limited to those described above.

As a method of imparting the polyvalent cation to the medium to be recorded, it is possible to use such a method that the polyvalent cation is applied onto the medium to be recorded in advance or a method of ejecting the polyvalent cation onto the entire image forming area through an ink jet head.

Further, to a method of applying the above described stimulus, various methods are applicable. As a preferred embodiment thereof, a stimulus application method in the case where the stimulus is the polyvalent cation will be described. For example, as described in JP-A Sho 64-63185, by an ink jet head, it is also possible to eject the polyvalent cation onto the entire image forming area. Further, it is also preferable that the medium to be recorded is subjected to treatment with the polyvalent cation in advance.

The ink composition for ink jet is used in an ink jet printer, which is applicable to various ink jet recording apparatuses using a piezo ink jet method employing a piezoelectric element, a bubble jet (registered trade name) method in which bubbles are generated by applying heat energy so as to effect recording.

Hereinbelow, an embodiment of constitutions of the ink jet recording apparatuses will be described with reference to the sole figure showing a block diagram of a constitution of the ink jet recording apparatus. The present invention is not limited thereto.

The figure shows the case where recording on a member to be recorded is effected by moving a head 70. Referring to the figure, a CPU 50 for controlling a general operation of the recording apparatus is connected with an X-direction drive motor 56 for driving the head 70 in X-direction and a Y-direction drive motor 58 for driving the head in Y-direction via an X-motor drive circuit 52 and a Y-motor drive circuit 54, respectively. In accordance with instructions from the CPU 50, the X-direction drive motor 56 and the Y-direction drive motor 58 are driven through the X-motor drive circuit 52 and the Y-motor drive circuit 54, respectively. As a result, a position of the head 70 with respect to the member to be recorded is determined.

As shown in the figure, to the head 70, a head drive circuit 60 is connected, in addition to the X-direction drive motor 56 and the Y-direction drive motor 58. The CPU 50 controls the head drive circuit 60 to effect drive of the head 70, i.e., ejection of ink for ink jet. Further, to the CPU 50, an X-encoder 62 and Y-encoder 64 for detecting positions of the head 70 are connected. Into these encoders, positional information of the head 70 is inputted. Further, a control program is stored in a program memory 66. The CPU 50 moves the head 70 on the basis of the control program and the positional information so as to be located at a desired position above the medium to be recorded and ejects the ink for ink jet through the head 70. In this manner, it is possible to form a desired image on the medium to be recorded. Further, in the case of an image recording apparatus capable of mounting therein a plurality of inks for ink jet, it is possible to effect desired image formation on the medium to be recorded by effecting the above described operation with respect to the respective inks for ink jet.

Further, after the ejection of the ink for ink jet, as desired, the head 70 is moved to a position at which removal means (not shown) for removing excessive ink deposited to the head 70 is disposed, so that it is also possible to clean the head 70 by wiping or the like. As a method of cleaning the head 70, it is possible to use a conventional cleaning method as it is.

After the image is formed, by a conveyance mechanism (not shown) for conveying the medium to be recorded, the image-formed medium to be recorded is replaced by a fresh medium to be recorded.

The above described embodiment may also be appropriately modified.

For example, in the above description, the head 70 is moved in the X and Y directions. However, by moving the head 70 in only the X direction (or only the Y direction) and moving the medium to be recorded in the Y direction (or the X direction), image formation may also be effected while effecting the movements in combination.

In the present invention, means (e.g., electrothermal converter or laser light) for generating heat energy as energy to be utilized for ejecting the ink for ink jet is provided so as to achieve an excellent effect by the head for ejecting the ink for ink jet through the heat energy. It is possible to effect further excellent image formation by using the ink composition for ink jet according to the present invention.

With respect to a typical constitution and principle of an apparatus provided with the above mentioned means for generating heat energy, for example, it is preferable that a basic principle as disclosed in U.S. Pat. Nos. 4,723,129 and 4,740,796 is employed. This principle is applicable to both of on demand-type and continuous-type. Particularly, in the case of the on demand-type, at least one drive signal, for causing quick temperature increase exceeding nucleate boiling, corresponding to ejection information is applied to the electrothermal converter which holds the liquid and is disposed in correspondence with a flow path. As a result, heat energy is generated in the electrothermal converter to cause a film boiling at a thermal action surface of the head. Consequently, this method is effective since it is possible to form bubbles in the liquid while establishing one-to-one correspondence with the drive signal. By ejecting the liquid through an ejection opening by the action of growth and contraction of bubble, at least one droplet is formed. When the drive signal is supplied in a pulse-like manner, the growth and contraction of bubble is appropriately effected instantaneously, so that ejection of liquid particularly excellent in responsiveness can be preferably achieved. As the pulse-like driving signal, those described in U.S. Pat. Nos. 4,463,359 and 4,345,262 are suitable. Incidentally, it is possible to effect further excellent ejection by employing a condition as described in U.S. Pat. No. 4,313,124 regarding a temperature increase rate at the thermal action surface.

As the constitution of the head, in addition to the above described constitution (linear liquid flow path or right-angle liquid flow path) of the combination of the ejection opening, the liquid path, and the electrothermal converter, it is also possible to use such a constitution that the thermal action portion is disposed in a bending area, e.g., as described in U.S. Pat. Nos. 4,558,333 and 4,459,600. Further, when other constitutions as described in JP-A Nos. Sho 59-123670 and Sho 59-138461 are employed, the effect of the present invention is also effectively achieved. In other words, even when the head has any constitution, according to the present invention, it is possible to efficiently effect the ejection of ink for ink jet with reliability.

Further, the present invention is also effectively applicable to a head of a full line-type such that the head has a length corresponding to a maximum width of the medium to be recorded used in the image forming apparatus of the present invention. The full line-type head may have a constitution satisfying the length of the head by a combination of a plurality of heads or a constitute including a single head which is integrally formed.

Further, with respect to a serial-type head, the present invention is effective in the case where the head is fixed in a main assembly of the image forming apparatus or the head is mounted in the apparatus main assembly to permit electrical connection with the apparatus main assembly and supply of ink from the apparatus main assembly.

Further, the image forming apparatus of the present invention may include a droplet-removing means, so that a further excellent ejection effect can be achieved.

Further, it is preferable that the effect of the present invention is further stabilized by additionally providing a preliminary auxiliary means or the like, such as a capping means for the head, pressure application or suction means, electrothermal converter or different heating element, preliminary heating means, or preliminary ejection means for effecting ejection other than ink ejection.

As a most effective method in the present invention, the above described filing boiling method is performed.

In the image forming apparatus of the present invention, an amount of ink ejected from each ejection opening of an ejection head of ink for ink jet may preferably be in the range of 0.1-100 picoliters.

Further, the ink composition of the present invention is also usable in an indirect recording apparatus using such a recording method that ink is printed onto an intermediary transfer member and then transferred onto the medium to be recorded. It is also possible to apply the ink composition of the present invention to an apparatus of a direct recording-type using the intermediary transfer member.

Hereinafter, the present invention will be described more specifically based on examples. However, the present invention is not limited to these examples.

### SYNTHESIS EXAMPLE

<Synthesis of Polymeric Compound>

Synthesis of a copolymer among 4-methylbenzeneoxyethyl vinyl ether (TolOVE), methoxyethyl vinyl ether (MOEOVE), and ethyl 4-{(vinyloxy)ethoxy}benzoate (VEtPhcobEt)

After air in a gloss vessel equipped with three-way stopcock was substituted with nitrogen, the glass vessel was heated at 250° C. in a nitrogen gas atmosphere to remove adsorbed water. After the system was returned to room temperature, 4-methylbenzeneoxyethyl vinyl ether (ToLOVE), ethyl acetate, 1-isobutoxyethyl acetate, and toluene were added into the system and the reaction system was cooled. When a temperature in the system reached 0° C., ethylaluminum sesquichloride (equimolar mixture of diethylaluminium chloride and ethylaluminum dichloride) was added and polymerization was started. During the polymerization, completion of the polymerization of TolOVE was confirmed by effecting monitoring using gel permeation chromatography (GPC) in which a molecular weight is time-divided.

Next, methoxyethoxyethyl vinyl ether (MOVOVE) was added into the reaction system. After completion of the polymerization was confirmed, ethyl 4-{(vinyloxy)ethoxy}benzoate (VEEtPhCOOEt) was added and the polymerization was continued. Then, completion of the polymerization of VEEtPhCOOEt was confirmed by monitoring using GPC, and the polymerization was terminated by adding 0.3 wt. % of ammonia/methanol aqueous solution into the system. The reaction mixture was diluted with dichloromethane and washed three times with 0.6M hydrochloric acid and three times with distilled water. The resultant organic layer was concentrated and dried by an evaporation to obtain a vacuum-dried product, followed by isolation to obtain an objective polymeric compound. The thus obtained polymeric compound was identified by NMR and GPC.

The isolated polymeric compound is a block copolymer constituted by a segment having a recurring structure of TolOVE, a segment having a recurring structure of MOEOVE, and a segment having a recurring structure of VEEtPhCOOEt.

In this synthesis example, four block copolymer (Block polymers 1 to 4) were prepared by changing a composition ratio among TolOVE, MOEOVE, and VEEtPhCOOEt.

Results of identification and solubility test of Block polymers 1 to 4 are shown in Table 1.

TABLE 1

| | | | TolOVE/ | Solu- | Solu- |
|---|---|---|---|---|---|
| | Mw | | MOEOVE/ | bility | bility |
| polymer | (×10³) | Mw/Mn | VEEtPtCOOEt | in DMSO*² | in water |
| BP*¹ 1 | 21.8 | 1.19 | 90/40/10 | soluble | Hardly |
| | | | | | soluble |
| BP 2 | 19.5 | 1.21 | 10/120/10 | soluble | soluble |
| BP 3 | 23.5 | 1.12 | 10/70/60 | Hardly | Soluble |
| | | | | soluble | in pH 12*³ |
| BP 4 | 21.3 | 1.15 | 90/20/20 | Hardly | Hardly |
| | | | | soluble | soluble |

*¹block polymer
*²dimethyl sulfoxide (aprotic solvent)
*³pH 12 aqueous solution (poor solvent as well as water)

### Example 1

In 100 wt. parts of dimethyl sulfoxide, 40 wt. parts of Block polymer 1 (polymeric compound) was dissolved in a vessel. Into the solution, 10 wt. parts of an azo pigment (C.I. Pigment Yellow 128) was added, followed by stirring for 2 hours in the vessel to obtain a suspension. In the suspension, an potassium hydroxide aqueous solution was added dropwise little by little to dissolve the azo pigment.

The thus obtained pigment solution was quickly injected with a syringe into distilled water stirred by a stirrer while effecting ultrasonic treatment to precipitate the azo pigment.

When an average particle size of the resultant polymeric pigment fine particles was measured by a measuring apparatus (“DLS-7000”, mfd. by Otsuka Electronic, Co., Ltd.), the measured average particle size was 23.3 nm. Further, a ratio of Mw (weight-average particle size)/Mn (number-average particle size) as an index for size uniformity was 1.10.

### Example 2

A quinacridone pigment (C.I. Pigment Red 122) was precipitated in the same manner as in Example 1 except that the organic pigment was changed from the azo pigment (C.I. Pigment Yellow 128) to the quinacridone pigment (C.I. Pigment Red 122).

When the average particle size of the resultant polymeric pigment fine particles was measured by DLS-7000, the measured average particle size was 26.2 nm. The ratio of Mw/Mn was 1.52.

### Comparative Example 1

An azo pigment (C.I. Pigment Yellow 128) was precipitated in the same manner as in Example 1 except that the polymeric compound was changed from Block polymer 1 to Block polymer 2.

When the average particle size was measured by DLS-7000, the measured average particle size was 104.4 nm.

### Comparative Example 2

An azo pigment (C.I. Pigment Yellow 128) was precipitated in the same manner as in Example 1 except that the polymeric compound was changed from Block polymer 1 to Block polymer 3 and the poor solvent was changed from water to an aqueous solution having a pH of 12 prepared by using 0.1N-NaOH aqueous solution.

When the resultant polymeric pigment fine particles were observed with eyes, it was confirmed that they formed agglomerate which was clearly observable with eyes.

### Comparative Example 3

An azo pigment (C.I. Pigment Yellow 128) was precipitated in the same manner as in Example 1 except that the polymeric compound was changed from Block polymer 1 to Block polymer 4.

When the resultant polymeric pigment fine particles were observed with eyes, it was confirmed that they formed agglomerate which was clearly observable with eyes.

<Preparation of Ink Composition>

From the liquid composition containing the polymeric pigment fine particles prepared in Example 1, dimethyl sulfoxide was removed by a dialysis membrane (molecular porous membrane tubing, “MWCO:3500”, mfd. by SPECTRUM Laboratories, Co. Ltd.). The resultant liquid composition was concentrated by an evaporator to obtain a concentrated liquid having a pigment content of 10 wt. %.

An ink composition was prepared by mixing 50 wt. parts of the concentrated liquid containing the polymeric pigment fine particle, 7.5 wt. parts of diethylene glycol, 5 wt. parts of glycerin, 5 wt. parts of trimethylolpropane, 0.2 wt. part of acetylenol EH, and 32.3 wt. parts of ion exchange water.

<Printing Evaluation>

The thus prepared ink composition was mounted in an ink jet printer (“BJF 800”, mfd. by Canon Inc.) and subjected to ink jet recording of a solid image on plain paper. When the solid image recorded in the plain paper was observed with eyes, it was confirmed that the solid image had a clear hue.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 313401/2005 filed Oct. 27, 2005, which is hereby incorporated by reference.

What is claimed:

1. A process for producing a liquid composition containing polymeric pigment fine particles comprising a pigment and a polymeric compound which is soluble in an aprotic solvent and hardly soluble in a poor solvent for the pigment, said process comprising:
a step of preparing a solution of the pigment and the polymeric compound in the aprotic solvent in the presence of alkali; and
a step of mixing the solution with the poor solvent for the pigment to precipitate the polymeric pigment fine particles comprising the pigment and the polymeric compound in a dispersion state.

2. A process according to claim 1, wherein the poor solvent for the pigment is water or an aqueous solution having a pH of 5 or more.

3. A process according to claim 1, wherein when the polymeric compound has a solubility parameter δp, the aprotic solvent has a solubility parameter δo, and the poor solvent has a solubility parameter δw, the solubility parameters δp, δo, and δw satisfying the following relationships:

|δp−δo| is 1.8 or less, and

|δp−δw| is more than 0.5.

4. A process according to claim 1, wherein the polymeric compound is a copolymer having a hydrophilic site and a hydrophobic group.

5. A process according to claim 4, wherein the copolymer is a block copolymer.

6. An ink composition for ink jet recording, comprising:
a liquid composition produced through a process according to claim 1.

7. An image forming method, comprising:
a step of recording an image by providing an ink composition according to claim 6 to a medium.

8. An image forming apparatus, comprising:
means for recording an image by providing a ink composition according to claim 6 to a medium.
